(19) United States
(12) Patent Application Publication
(10) Pub. No.: US 2011/0064330 A1
(43) Pub. Date: Mar. 17, 2011

(54) IMAGE SELECTION SYSTEM, IMAGE OUTPUT APPARATUS, PORTABLE TERMINAL, IMAGE SELECTION METHOD AND PROGRAM

(76) Inventor: Yasushi Hikichi, Tokyo (JP)

(21) Appl. No.: 12/736,716

(22) PCT Filed: Jun. 16, 2008
(86) PCT No.: PCT/JP2008/060967

§ 371 Date: Nov. 3, 2010

(51) Int. Cl. G06K 9/54; G06F 15/00

(52) U.S. Cl. 382/305; 358/1.15

(57) ABSTRACT

An image selection system is composed of an image output apparatus and a portable terminal that supplies image files indicating images that are to be supplied as output by the image output apparatus. The portable terminal includes a display unit and at least one decoder that decodes image files. The image output apparatus includes a plurality of decoders that each decode various types of image files. The portable terminal transmits to the image output apparatus information indicating the image file formats that can be decoded in the portable terminal, and the image output apparatus, having received the information indicating the image file formats that was transmitted from the portable terminal, transmits converted image files in which images held by the image output apparatus are converted to an image file format that was indicated by the received information. The portable terminal then receives and decodes image files transmitted from the image output apparatus and displays the images on the display unit.

### TECHNICAL FIELD

The present invention relates to an image selection system, an image output apparatus, a portable terminal, an image selection method, and a program that use a portable terminal.

### BACKGROUND ART

The development of functions in portable terminals such as portable telephone terminals in recent years has been remarkable, and the screen display of text or images created by personal computers has become possible. In addition, communication functions provided in portable terminals also cover a broad range and connection with various information processing apparatuses in offices by way of wireless LAN or Bluetooth is now easy.

It is assumed that, by facilitating the connection of a portable terminal to various information processing apparatuses in an office, the information processing devices can be caused to carry out processing by way of instructions from the portable terminal. For example, a printer can be instructed to print an image or a projector can be instructed to project an image from the portable terminal.

When a user instructs the printing of an image to a printer or instructs the projection of an image to a projector from a portable terminal, convenience is enhanced by displaying of the image on the portable terminal to enable checking of the content of the image.

However, portable terminals that have been miniaturized to improve portability and that consequently have small display screens are unable to display images whose sizes have been predetermined for display on personal computers unless the images are altered.

A technique for displaying on a portable terminal an image that is to be printed when a portable terminal instructs a printer to print the images is disclosed in, for example, Japanese Patent Application No. 2006-163794.

According to this technique, a large image that is meant for display on a personal computer is transmitted from the portable terminal to a printer that is connected to the portable terminal, the image received by the printer is reduced to a size that can be displayed on the portable terminal and then transmitted to the portable terminal, and the reduced image is then displayed on the portable terminal.

The display of an image on a portable terminal entails the problem regarding size of the image as described hereinabove, and also entails a problem regarding the image file format. In order to display an image on a portable terminal, a decoder for decoding the encoded image file must be incorporated in the portable terminal. However, various types of methods exist for encoding images, and the image file formats differ. In order to decode image files, a decoder that matches the image file format must be incorporated in advance in the portable terminal. The decoder is an apparatus or software that decodes data that have been encoded based on set rules and extracts the original data, a decoder that can decode JPEG-formatted images being necessary to display an image in JPEG (Joint Photographic Experts Group) format, and a decoder that can decode BMP (Bit MaP)-formatted image files being necessary to display an image in BMP format.

In a compact portable terminal, memory capacity is limited and the incorporation of decoders that can decode various types of image file formats is not realistic. As a result, the types of decoders that are incorporated are limited, the image file formats that can be decoded are limited, and many images cannot be displayed on a portable terminal.

In the technique disclosed in the above-described JP-A-2006-163794, reducing an image in a printer to a size that can be displayed on a portable terminal solves the problem relating to the size of an image. However, because the image file format is not converted in this technique, the image cannot be displayed on a portable terminal when the image is in an image file format for which a decoder has not been incorporated in the portable terminal.

### DISCLOSURE OF THE INVENTION

It is an object of the present invention to provide an image selection system, an image output apparatus, a portable terminal, an image selection method, and a program that enables the display on a portable terminal of an image of an image file format for which a decoder has not been incorporated in the portable terminal.

The present invention for achieving the above-described object is an image selection system that facilitates selection of output images and that is composed of an image output apparatus and a portable terminal that supplies image files indicating images that are to be supplied as output by the image output apparatus; wherein: the portable terminal is equipped with:

a display unit; and

a portable-side information processor equipped with at least one decoder that decodes image files;

the image output apparatus is equipped with an image output apparatus-side information processor that is provided with a plurality of decoders that each decode various types of image files;

the portable-side information processor transmits information indicating image file formats that can be decoded by the portable-side information processor to the image output apparatus-side information processor and then receives and decodes image files from the image output apparatus-side information processor and displays on the display unit; and

the image output apparatus-side information processor, upon receiving information indicating image file formats from the portable-side information processor, generates converted image files in which images held by the image output apparatus are converted to an image file format indicated by the received information and transmits the converted image files to the portable-side information processor.

In addition, in an image output apparatus that includes an image output apparatus-side information processor provided with a plurality of decoders that each decode various types of image files, the image output apparatus-side information processor, upon receiving information indicating image file formats, generates a converted image file in which an image held by the image output apparatus is converted to an image file format indicated by the received information and transmits the converted image file to the transmission origin of the information that indicates the image file format.

In addition, the portable terminal of the present invention can select images that are to be supplied as output by an image output apparatus and is equipped with a display unit and a portable-side information processor equipped with at least one decoder that decodes image files, wherein the portable-side information processor transmits to the image output apparatus-side information processor information indicating image file formats that can be decoded by the portable-side information processor, and then receives and decodes image files from the image output apparatus and displays on the display unit.

In addition, the image selection method of the present invention facilitates the selection of output images and is composed of: an image output apparatus equipped with an image output apparatus-side information processor provided with a plurality of decoders that each decode various types of image files; and a portable terminal that supplies image files that indicate images that are to be supplied as output by the image output apparatus and that is equipped with a display unit and a portable-side information processor equipped with at least one decoder that decodes image files, the image selection method including processes of:

the portable-side information processor transmitting to the image output apparatus-side information processor information indicating image file formats that the portable-side information processor can decode;

upon receiving information indicating image file formats from the portable-side information processor, the image output apparatus-side information processor generating a converted image file in which an image held by the image output apparatus is converted to an image file format indicated by the received information and transmitting the generated converted image file to the portable-side information processor; and

the portable-side information processor receiving and decoding the image file from the image output apparatus-side information processor and then displaying on the display unit.

In addition, the image output apparatus that includes an image output apparatus-side information processor provided with a plurality of decoders that each decode various types of image files is caused to realize functions of:

the image output apparatus-side information processor, upon receiving information indicating image file formats, generating a converted image file in which an image held by the image output apparatus is converted to an image file format indicated by the received information and transmitting the converted image file to the transmission origin of the information indicating the image file format.

Due to the configuration described hereinabove, the present invention enables the display of an image on a portable terminal even in the case of an image in an image file format for which a decoder has not been incorporated into the portable terminal.

### BRIEF DESCRIPTION OF THE DRAWINGS

FIG. 1 shows a display screen of a portable terminal and shows a state in which only image file names of images stored in the portable terminal are displayed;

FIG. 2 shows the display screen of a portable terminal and shows a state in which thumbnail images of images stored in the portable terminal are displayed;

FIG. 3 shows the display screen of a portable terminal and shows a state in which thumbnail images of only a portion of images stored in the portable terminal are displayed;

FIG. 4 is a block diagram showing the first exemplary embodiment of the image selection system of the present invention;

FIG. 5 is a flow chart for explaining the operation of the first exemplary embodiment and shows the operations of a portable terminal and projector in the image selection system shown in FIG. 4 up to the display of a thumbnail image of an image used in a presentation in the display unit of the portable terminal;

FIG. 6 shows the display unit of a portable terminal and shows a state in which the process has transitioned to the presentation mode;

FIG. 7 shows the display unit of a portable terminal and shows a state in which thumbnail images of all images used in a presentation are displayed;

FIG. 8 is a flow chart for explaining the operation of the first exemplary embodiment and shows operations of a portable terminal and projector in the image selection system shown in FIG. 4 when a person conducting a presentation selects a thumbnail image that is displayed on the portable terminal and instructs image selection to the projector;

FIG. 9 shows an example of thumbnail images that are displayed in the display unit of a portable terminal;

FIG. 10 is a flow chart for explaining operations of the first exemplary embodiment and shows the operations of a portable terminal and a projector in the image selection system shown in FIG. 4 when the person conducting a presentation instructs image rotation to the projector from the portable terminal;

FIG. 11 shows an example of thumbnail images that are displayed on the display unit of a portable terminal after instructing image rotation;

FIG. 12 is a block diagram showing the second exemplary embodiment of the image selection system of the present invention;

FIG. 13 is a flow chart for explaining the operations of the second exemplary embodiment and shows the operations of the portable terminal and the projector in the image selection system shown in FIG. 12 up to the display of the thumbnail image of an image stored in the projector on the display unit of the portable terminal; and

FIG. 14 shows the display unit of a portable terminal in which thumbnail images of all images to be used in a presentation are displayed.

### BEST MODE FOR CARRYING OUT THE INVENTION

Exemplary embodiments of the image selection system of the present invention are next described with reference to the accompanying figures taking as an example a case in which a portable terminal and projector are connected and a presentation conducted.

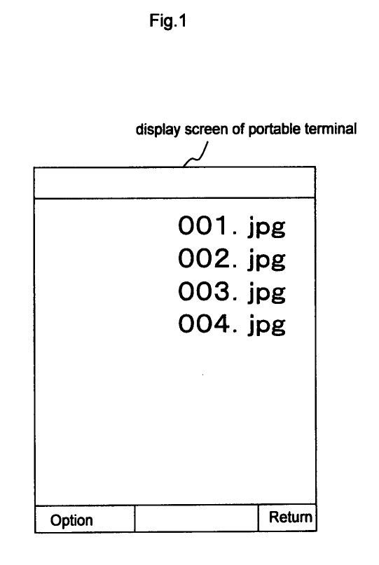

FIG. 1 shows the display screen of the portable terminal and shows a state in which only image file names of images stored in the portable terminal are displayed.

When a person such as a person conducting a presentation and who is to select an image performs input to the portable terminal for selecting an image file name displayed on the display screen of the portable terminal, the image resulting from the image file is projected by the projector, but when only image file names are displayed as shown in FIG. 1, the content of the image to be selected cannot be checked beforehand, and this inability compromises the convenience of this system.

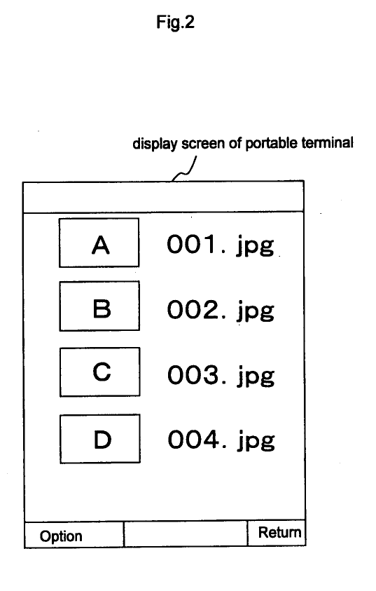

FIG. 2 shows the display screen of the portable terminal and shows a state in which thumbnail images of the images stored in the portable terminal are displayed. Thumbnail images are images that have been reduced for displaying a list of images. In addition, thumbnail images are images that have been reduced without converting the image file format.

When thumbnail images are displayed on the display screen of a portable terminal in this way, the person giving a presentation and who is to select images is able to check the content that is to be selected beforehand, resulting in enhanced convenience.

However, as described hereinabove, an image in an image file format for which a decoder has not been incorporated in the portable terminal cannot be displayed on the portable terminal.

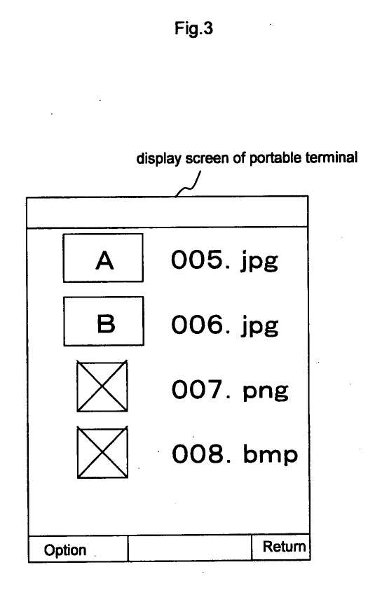

FIG. 3 is the display screen of a portable terminal and shows a state in which thumbnail images of only a portion of the images that are stored in the portable terminal are displayed.

As shown in FIG. 3, the third and fourth thumbnail images are thumbnail images in image file formats for which decoders have not been incorporated in the portable terminal, and the thumbnail images therefore cannot be displayed. In such cases, the person giving a presentation and who is to select images is unable to check the content for these images beforehand.

In the exemplary embodiments described hereinbelow, a case is described in which a person giving a presentation selects images that are to be projected by a projector while referring to thumbnail images on a portable terminal.

### First Exemplary Embodiment

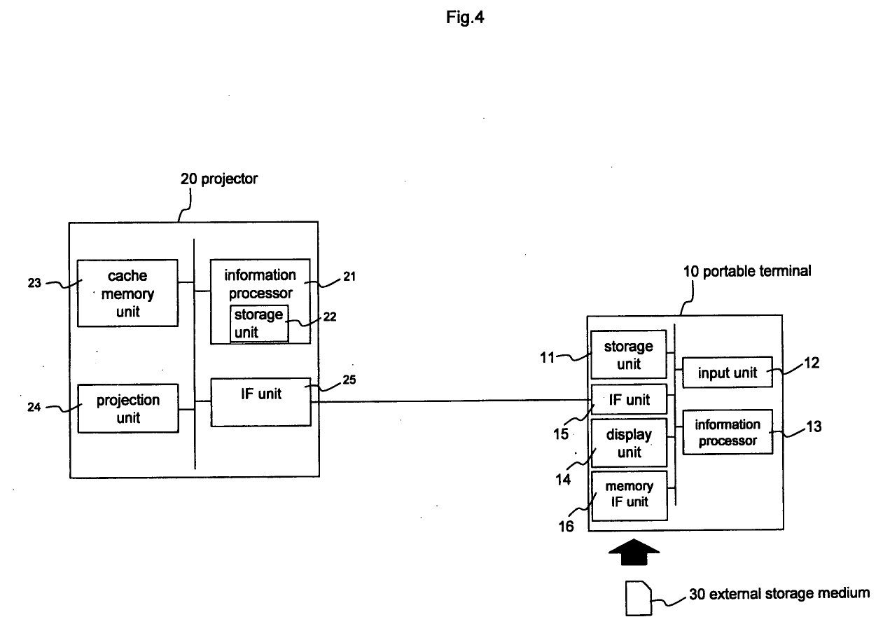

FIG. 4 is a block diagram showing the first exemplary embodiment of the image selection system of the present invention.

The image selection system of the present invention as shown in FIG. 4 is made up from: portable terminal 10, projector 20 that is connected by cable or wirelessly to portable terminal 10, and external storage medium 30.

As a summary of the first exemplary embodiment, portable terminal 10 first transmits images that are to be used in a presentation to projector 20. Projector 20 decodes and stores the image files that are received and further generates thumbnail image files from the received image files. Projector 20 then transmits the generated thumbnail image files to portable terminal 10, and portable terminal 10 decodes and displays the thumbnail image files that were received. Through selection of thumbnail images from portable terminal 10, projector 20 is instructed to project and to rotate the images.

Because projector 20 must display images of various types, projector 20 is able to decode various image files including typically used image file formats such as JPEG, GIF (Graphic Interchange Format), BMP, and PNG (Portable Network Graphics).

Portable terminal 10 includes: storage unit 11 that is the portable-side storage unit, input unit 12, information processor 13 that is the portable-side information processor, display unit 14, IF (interface) unit 15, and memory IF unit 16.

Storage unit 11 stores image files.

Input unit 12 is a component that accepts input from, for example, a person giving a presentation, and accepts the input such as switching to the presentation mode, which is the mode used at the time of a presentation, or such as image selection carried out when selecting images, and reports the content of such input to information processor 13.

Information processor 13 is a component that controls the operation of portable terminal 10, representative operations appearing hereinbelow.

(1) Information processor 13 switches portable terminal 10 to the presentation mode in accordance with notification from input unit 12.

(2) Upon connection of portable terminal 10 and projector 20, information processor 13 transmits to projector 20 information indicating the image file formats that storage unit 11 stores and that portable terminal 10 is capable of decoding.

(3) Information processor 13 acquires image file formats that can be decoded by portable terminal 10 from storage unit 11 and checks whether an image file stored in storage unit 11 or external storage medium 30 can be decoded or not. If there is an image file in an image file format that cannot be decoded, information processor 13 transmits to projector 20 this image file, a thumbnail generation request, and information indicating the image file formats that can be decoded.

(4) When there is an image file in an image file format that can be decoded in (3), information processor 13 generates a thumbnail image file in which this image file has been decoded. Information processor 13 then transmits this image file and the generated thumbnail image file to projector 20.

(5) Upon receiving a thumbnail image file from projector 20, information processor 13 decodes the received thumbnail image file and transmits it to display unit 14, and further, stores the thumbnail image file in storage unit 11.

(6) Information processor 13 receives information of image selection or image rotation that the person giving a presentation has entered by way of input unit 12 and transmits to projector 20 an image selection instruction or image rotation instruction together with the thumbnail image file name of the relevant image.

Display unit 14 performs display according to each function of portable terminal 10 and therefore displays the thumbnail images received from information processor 13 in the present exemplary embodiment. Display unit 14 further displays a rotation direction selection bar used for instructing the rotation of an image by, for example, a person giving a presentation.

IF unit 15 intermediates in the transmission and reception of, for example, image files with projector 20.

Memory IF unit 16 mounts external storage medium 30.

Projector 20 includes: information processor 21 that is the image output apparatus-side information processor and that includes storage unit 22, cache memory unit 23 that is the image output apparatus-side storage unit, projection unit 24 that is the image output unit, and IF unit 25.

Upon receiving an image file from portable terminal 10, information processor 21 first decodes the image file. The process is then split into the following two operations according to whether a thumbnail generation request is included in the received information.

If a thumbnail generation request is included in the information received from portable terminal 10, information processor 21 first generates a thumbnail image file from the received image file in the image file format that has been received and that can be decoded. Information processor 21 next stores the decoded image in cache memory unit 23 and stores the address in cache memory unit 23 where the image is stored as well as the file name of the generated thumbnail image file in association with each other in storage unit 22. Information processor 21 then transmits the generated thumbnail image file to portable terminal 10 by way of IF unit 25.

On the other hand, when a thumbnail generation request is not included in the information received from portable terminal 10, information processor 21 first stores the decoded image in cache memory unit 23, and stores the address in cache memory unit 23 where the image is stored as well as the file name of the received thumbnail image file in association with each other in storage unit 22. Information processor 21 then transmits the received thumbnail image file to portable terminal 10 by way of IF unit 25.

Alternatively, if information processor 21 receives an image selection instruction from portable terminal 10, information processor 21 searches storage unit 22 for the file name of the thumbnail image file that was received together with the image selection instruction and acquires the address of cache memory unit 23 that corresponds to the file name. Information processor 21 then acquires the image that is stored at the acquired address of cache memory unit 23 and transmits the image to projection unit 24.

Upon receiving an image rotation instruction from portable terminal 10, information processor 21 searches storage unit 22 by means of the file name of the thumbnail image file that was received together with this image rotation instruction and thus acquires the address of cache memory unit 23 that corresponds to this file name.

Information processor 21 next acquires the image that is stored at the acquired address of cache memory unit 23 and rotates the image in accordance with the instruction contained in the image rotation instruction. Information processor 21 then again stores the image that was rotated in cache memory unit 23, generates a thumbnail image file from the image that was rotated, and transmits the thumbnail image file to portable terminal 10 by way of IF unit 25.

Storage unit 22 stores the address in cache memory unit 23 where the image received from portable terminal 10 is stored as well as the file name of the thumbnail image file that was generated from the image in association with each other.

Cache memory unit 23 stores the decoded image that was received from information processor 21.

Projection unit 24 projects the image that was transmitted from information processor 21.

IF unit 25 intermediates in the transmission and reception of, for example, images with portable terminal 10.

External storage medium 30 stores image files in which images that are to be used in a presentation are encoded.

The operations in a presentation system that is configured as described hereinabove are next described up to the display, as thumbnail images on display unit 14 of portable terminal 11, of images that are stored in portable terminal 10 and that are to be used in a presentation.

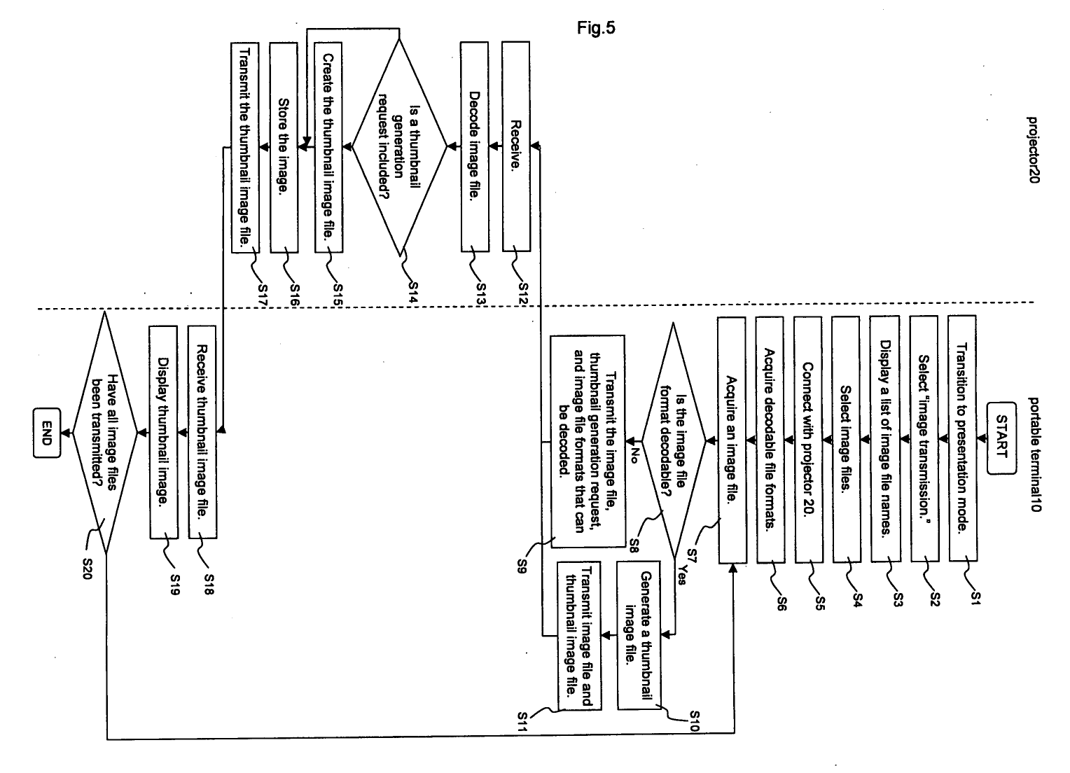

FIG. 5 is a flow chart for explaining the operations of the first exemplary embodiment, and shows the operations of portable terminal 10 and projector 20 in the image selection system shown in FIG. 4 up to the display on display unit 14 of portable terminal 10 of thumbnail images of images that are to be used in a presentation.

A person such as the person giving the presentation switches portable terminal 10 to the presentation mode through input unit 12 (Step 1).

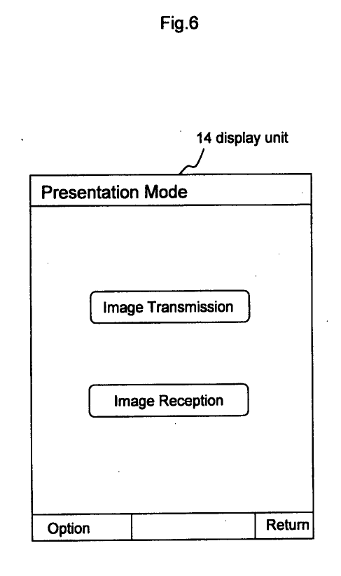

FIG. 6 shows display unit 14 of portable terminal 10 and shows a state in which the process has transitioned to the presentation mode.

Upon transition to the presentation mode as shown in FIG. 6, a screen is displayed prompting the selection of the transmission of an image file that is stored in storage unit 11 of portable terminal 10 or in external storage medium 30 to projector 20 or the reception of a thumbnail image file from projector 20. A person such as the person giving the presentation here selects “image transmission” (Step 2). A case of selecting “image reception” is described in the second exemplary embodiment described hereinbelow.

Upon receiving “image transmission” by way of input unit 12, information processor 13 of portable terminal 10 acquires from storage unit 11 the file names of image files that are stored in storage unit 11 and displays these file names on display unit 14. If external storage medium 30 is installed at memory IF unit 16, information processor 13 also acquires the file names of image files stored in external storage medium 30 and displays these names on display unit 14 (Step 3).

The screen that is here displayed on display unit 14 is, for example, a screen in which only file names are displayed as a list as shown in FIG. 1 and images are not displayed.

The person giving the presentation then selects all image files that are to be used in the presentation by way of input unit 12 (Step 4) and connects IF unit 15 of portable terminal 10 with IF unit 25 of projector 20 (Step 5).

When connection is established between portable terminal 10 and projector 20, information processor 13 of portable terminal 10 acquires the image file formats for which decoding is possible from storage unit 11 (Step 6).

Information processor 13 further acquires from storage unit 11 the image file having the file name that is displayed first from among the image files for which file names were listed in Step 3 (Step 7).

Information processor 13 then checks whether the acquired image file can be decoded or not (Step 8).

If it is verified in Step 8 that the image file format of the image file that was acquired from storage unit 11 cannot be decoded, information processor 13 transmits the image file that was acquired from storage unit 11, a thumbnail generation request, and information indicating the image file formats for which decoding is possible to projector 20 by way of IF unit 15 (Step 9).

In the present exemplary embodiment, the image file formats for which decoding is possible in portable terminal 10 are limited to only JPEG, as an example.

If it is verified in Step 8 that decoding is possible for the image file format of the image file acquired from storage unit 11, information processor 13 decodes the image file and generates a thumbnail image file (Step 10) and transmits the image file and thumbnail image file that was generated to projector 20 by way of IF unit 15 (Step 11).

Information processor 21 of projector 20 receives the image file from portable terminal 10 by way of IF unit 25 (Step 12) and decodes the image file that was received (Step 13). Information processor 21 then checks whether a thumbnail generation request is included in the received information (Step 14).

If a thumbnail generation request is included in the received information from portable terminal 10, information processor 21 first generates a thumbnail image file from the image file that was received in the received image file format for which decoding is possible (Step 15).

Information processor 21 next stores the decoded image in cache memory unit 23 (Step 16), and stores the address in cache memory unit 23 where the decoded image is stored as well as the file name of the thumbnail image file that was generated in association with each other in storage unit 22. Information processor 21 then transmits the generated thumbnail image file to portable terminal 10 by way of IF unit 25 (Step 17).

On the other hand, if a thumbnail generation request is not included in the transmission received from portable terminal 10, information processor 21 proceeds to the process of Step 16, stores the decoded image in cache memory unit 23, and stores the address in cache memory unit 23 where the decoded image is stored as well as the file name of the thumbnail image file that was received in association with each other in storage unit 22. Information processor 21 then transmits the thumbnail image file that was received to portable terminal 10 by way of IF unit 25.

Information processor 13 of portable terminal 10 receives the thumbnail image file from projector 20 by way of IF unit 15 (Step 18) and decodes the thumbnail image file that was received and displays the thumbnail image on display unit 14 (Step 19).

Information processor 13 subsequently checks whether all of the image files that were selected by the person giving the presentation in Step 4 have been transmitted to projector 20 (Step 20), and the processes of Steps 7-19 are repeated until all of the selected image files have been transmitted to projector. 20. In this way, all of the images selected by the person giving the presentation are stored in cache memory unit 23 of projector 20 and the thumbnail images corresponding to these images are displayed on display unit 14 of portable terminal 10. These repeated processes are carried out automatically for the second and following images in the background while the presentation proceeds using the first image.

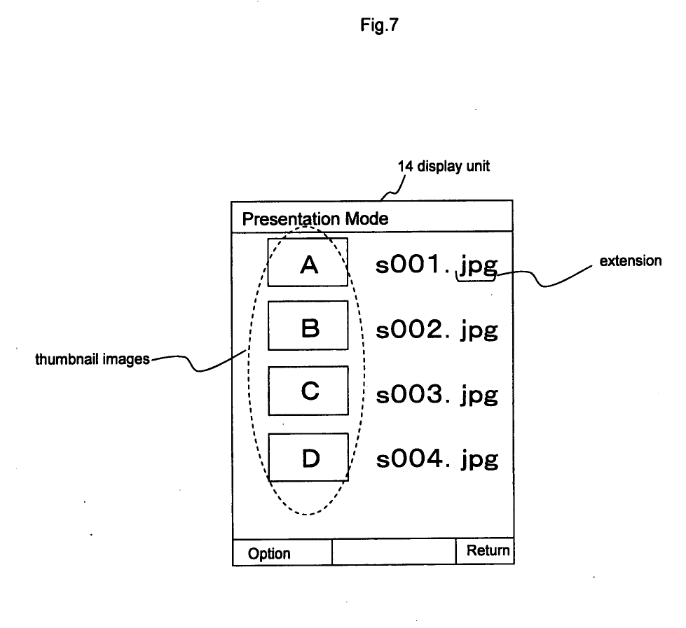

FIG. 7 shows display unit 14 of portable terminal 10 and shows a state in which thumbnail images of all images that are to be used in a presentation are displayed.

In display unit 14 of portable terminal 10 as shown in FIG. 7, not only are image file names displayed, but thumbnail images are also displayed. In addition, the image file format for which decoding is possible in portable terminal 10 is only JPEG, and as can be seen from the extension portion, all of the thumbnail image files are in the JPEG format.

After display of the thumbnail images on display unit 14 of portable terminal 10, images can be quickly projected in projector 20 by only an image selection instruction from portable terminal 10 because the images are stored in cache memory unit 23 of projector 20.

A case is next described in which the person giving the presentation selects a thumbnail image that is displayed on portable terminal 10 and causes projection of the image corresponding to the selected thumbnail image in projector 20. As an example, it is here assumed that s002.jpg, which is the second thumbnail image shown in FIG. 7, is selected.

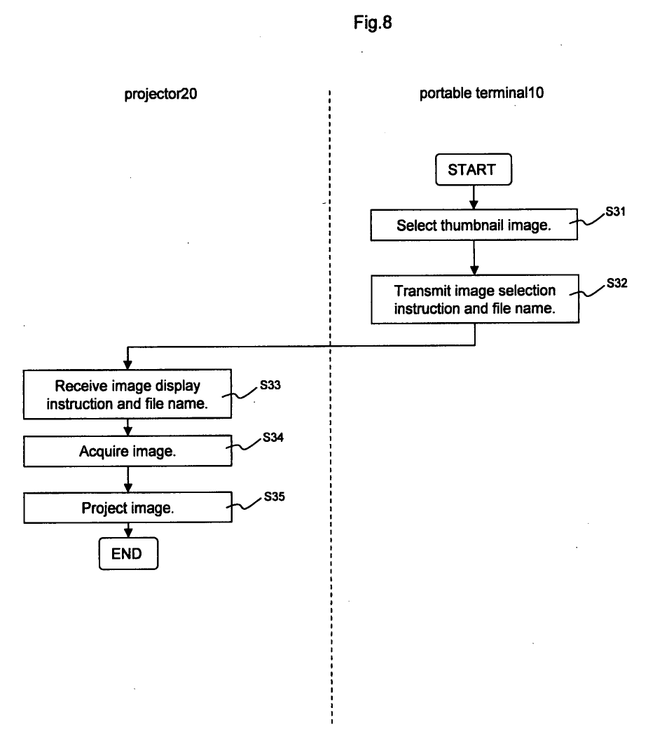

FIG. 8 is a flow chart for explaining the operations of the first exemplary embodiment and shows the operations in portable terminal 10 and projector 20 in the image selection system shown in FIG. 4 when a person giving a presentation selects a thumbnail image displayed in portable terminal 10 and instructs image selection to projector 20.

A person such as a person giving a presentation first selects by way of input unit 12 the thumbnail image of an image that he or she wishes to have displayed on projector 20 from the thumbnail images displayed on display unit 14 of portable terminal 10 (Step 31).

Input unit 12 recognizes the file name of the selected thumbnail image and transmits the file name to information processor 13.

Information processor 13, having received the file name of the thumbnail image from input unit 12, transmits an image selection instruction and the file name “s002.jpg” to projector 20 by way of IF unit 15 (Step 32).

Information processor 21 of projector 20 receives the image selection instruction and file name “s002.jpg” from portable terminal 10 by way of IF unit 25 (Step 33). Information processor 21 then searches storage unit 22 for the received file name “s002.jpg” and acquires the corresponding address in cache memory unit 23. Information processor 21 then acquires the image that is stored at the address that was acquired (Step 34) and transmits the image to projection unit 24.

Projection unit 24 that has received the image from information processor 21 projects the image (Step 35).

A case is next described in which the person giving the presentation selects a thumbnail image that is displayed on portable terminal 10 and rotates the image that corresponds to the selected thumbnail image.

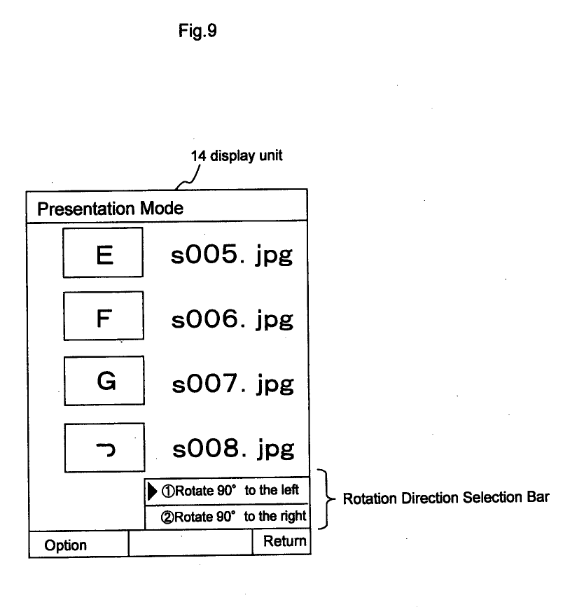

FIG. 9 shows an example of thumbnail images that are displayed on display unit 14 of portable terminal 10.

As shown in FIG. 9, the image of thumbnail image file name s008.jpg is originally intended for portrait display but is displayed in landscape format. In this case, the image that is the basis of this thumbnail image that is stored in cache memory unit 23 of projector 20 is also stored in a landscape format, and if an image selection instruction of this image is carried out from portable terminal 10 without any alteration, projector 20 will perform portrait display without alteration.

In addition, as shown in FIG. 9, a rotation direction selection bar that enables instruction of vertical/horizontal conversion is displayed together with the thumbnail images on display unit 14.

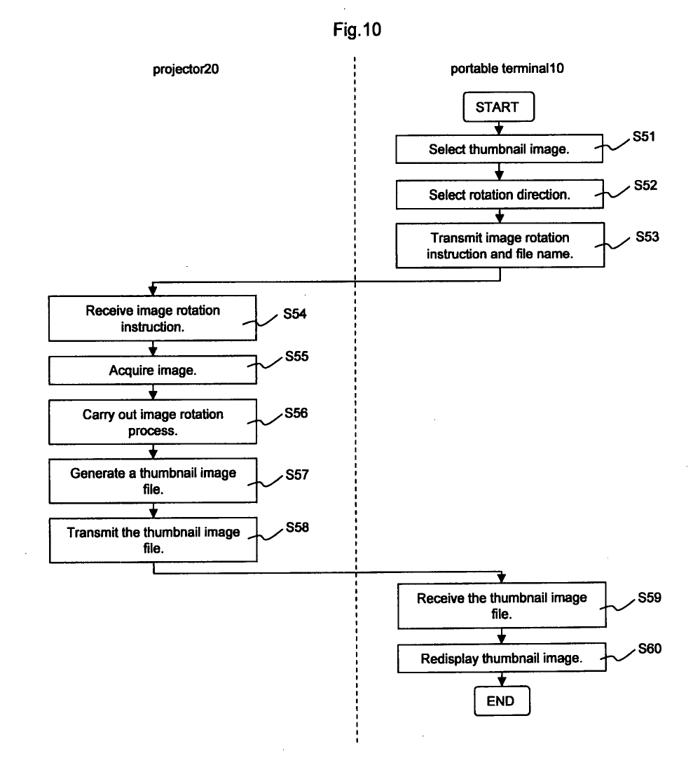

FIG. 10 is a flow chart for explaining the operations of the first exemplary embodiment and shows the operations of portable terminal 10 and projector 20 in the image selection system shown in FIG. 4 when a person such as a person giving a presentation gives an image rotation instruction to projector 20 from portable terminal 10.

The person giving the presentation first selects by way of input unit 12 the landscape format thumbnail image that he or she wishes to rotate that is displayed on display unit 14 of portable terminal 10 (Step 51). It is here assumed that the file has the thumbnail image file name “s008.jpg” as described hereinabove.

The person giving the presentation next selects through input unit 12 whether to rotate 90° to the right or 90° to the left from the rotation direction selection bar (Step 52).

Input unit 12 recognizes the file name “s008.jpg” of the selected thumbnail image and the rotation direction and transmits the thumbnail image file name and rotation direction to information processor 13.

Information processor 13, having received the thumbnail image file name and rotation direction from input unit 12, transmits an image rotation instruction and the file name “s008.jpg” to projector 20 by way of IF unit 15 (Step 53).

Information processor 21 of projector 20 receives the image rotation instruction and the file name “s008.jpg” from portable terminal 10 by way of IF unit 25 (Step 54).

Information processor 21 then searches storage unit 22 for the file name “s008.jpg” that was received and acquires the corresponding address in cache memory unit 23.

Information processor 21 then acquires the image that is stored at the acquired address of cache memory unit 23 (Step 55), causes the acquired image to rotate 90° to the right or 90° to the left in accordance with the instruction contained in the image rotation instruction (Step 56), and again stores the image that has been rotated in cache memory unit 23.

Information processor 21 further generates a thumbnail image file from the rotated image (Step 57) and transmits the generated thumbnail image file to portable terminal 10 by way of IF unit 25 (Step 58).

Information processor 13 of portable terminal 10 receives the thumbnail image file that has been generated from the rotated image from projector 20 by way of IF unit 15 (Step 59), decodes this thumbnail image file, and displays the thumbnail image on display unit 14 (Step 60).

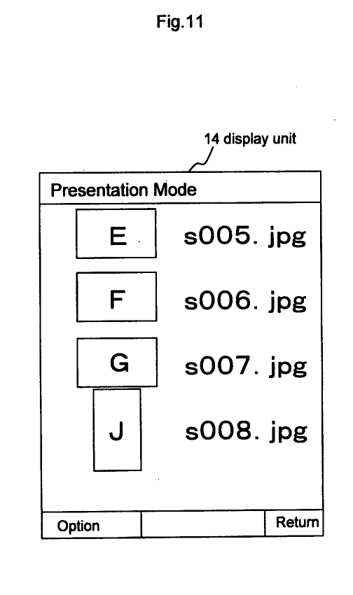

FIG. 11 shows an example of the thumbnail images that are displayed on display unit 14 of portable terminal 10 following the image rotation instruction.

As shown in FIG. 11, the thumbnail image of the file name “s008.jpg” that was displayed in landscape format is now displayed in portrait format.

Thus, in the present exemplary embodiment, the thumbnail image of an image can be displayed on portable terminal 10 even when the image file that is to be used in a presentation is an image file in an image file format for which decoding is not possible in portable terminal 10.

In addition, all images that are to be used in a presentation are transmitted to projector 20 from portable terminal 10 and stored in the background while the presentation is being given, whereby the images can subsequently be quickly projected in projector 20 by a simple image selection instruction from portable terminal 10.

Still further, the rotation of an image can be instructed to projector 20 by checking the thumbnail image that is displayed on portable terminal 10.

In the above-described first exemplary embodiment, thumbnail images in an image file format that can be decoded in portable terminal 10 were also transmitted to projector 20. As another example, when an image is in an image file format that can be decoded in portable terminal 10, only the file name of the thumbnail image can be transmitted to projector 20 without transmitting a thumbnail image to projector 20. In this case, the traffic between portable terminal 10 and projector 20 can be reduced.

In the above-described first exemplary embodiment, an example was described in which the second and succeeding images were transmitted from portable terminal 10 to projector 20 in the background while a presentation was conducted using the first image. As another example, all of the images can also be transmitted in a batch in the beginning from portable terminal 10 to projector 20.

### Second Exemplary Embodiment

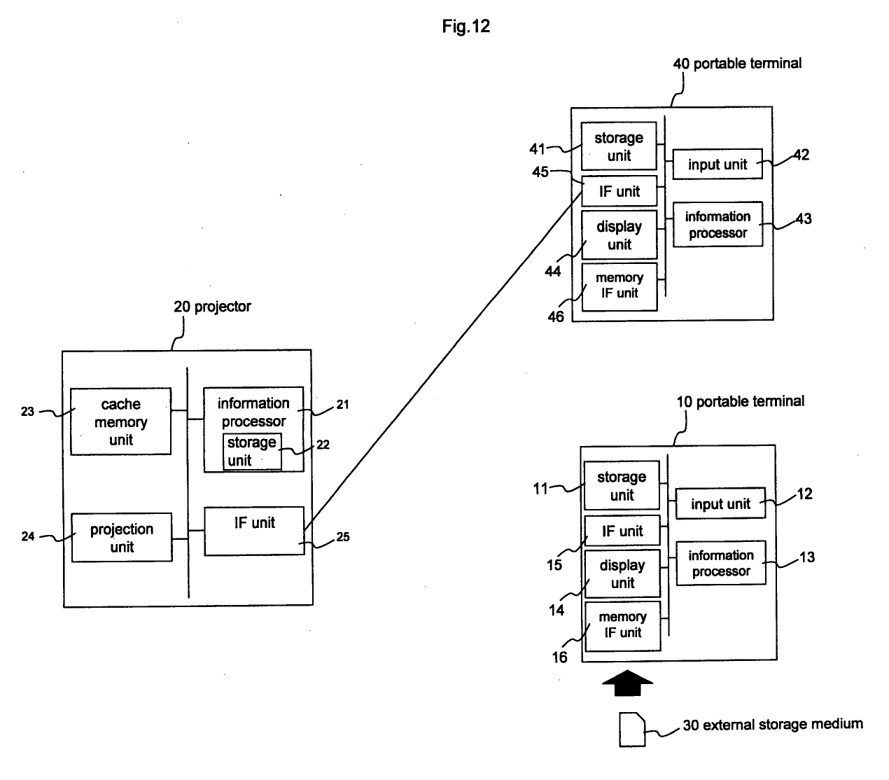

FIG. 12 is a block diagram showing the second exemplary embodiment of the image selection system of the present invention.

As shown in FIG. 12, the presentation system of the present exemplary embodiment differs from the system shown in the first exemplary embodiment in that portable terminal 40 has been added. Portable terminal 10 and portable terminal 40 have equivalent functions.

In the present exemplary embodiment, it will be assumed that portable terminal 40, which differs from portable terminal 10 that has transmitted images to projector 20, receives the thumbnail images of images that are to be used in a presentation from projector 20 and that image selection instructions are issued to projector 20 from portable terminal 40.

In the present exemplary embodiment, images that are to be used in a presentation have already been stored in cache memory unit 23 of projector 20.

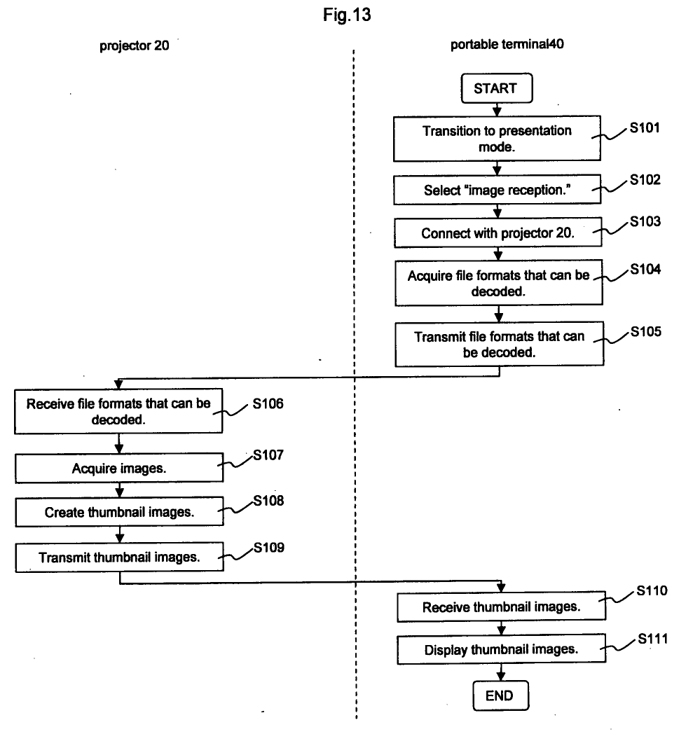

FIG. 13 is a flow chart for explaining the operations of the second exemplary embodiment and shows the operations of portable terminal 40 and projector 20 in the image selection system shown in FIG. 12 up to the display on display unit 44 of portable terminal 40 of thumbnail images of images that are stored in projector 20.

A person such as a person giving a presentation first switches portable terminal 40 to the presentation mode by way of input unit 42 (Step 101).

Upon proceeding to the presentation mode, a selection screen such as shown in FIG. 6 is displayed on display unit 44, but in this case, “image reception” is selected (Step 102).

The person giving the presentation next connects portable terminal 40 to projector 20 (Step 103).

When a connection between portable terminal 40 and projector 20 is established, information processor 43 of portable terminal 40 acquires from storage unit 41 information indicating the image file formats that can be decoded in portable terminal 40 (Step 104) and transmits this information to projector 20 by way of IF unit 45 (Step 105).

In the present exemplary embodiment, the image file format that can be decoded in portable terminal 40 is assumed to be, as an example, only GIF.

Information processor 21 of projector 20 receives information indicating the image file format that can be decoded from portable terminal 40 by way of IF unit 25 (Step 106).

Information processor 21 next acquires from cache memory unit 23 all of the images that are stored in cache memory unit 23 (Step 107) and generates thumbnail image files from each of the images in the received image file format that can be decoded (Step 108). In this case, the thumbnail image files are generated in GIF format.

Information processor 21 then stores in storage unit 22 the file names of the generated thumbnail image files and, in association with these file names, the addresses in cache memory unit 23 at which the images corresponding to these thumbnail image files are stored. Information processor 21 then transmits the generated thumbnail image files to portable terminal 40 by way of IF unit 25 (Step 109).

Information processor 43 of portable terminal 40 receives the thumbnail image files from projector 20 by way of IF unit 45 (Step 110) and then decodes the received thumbnail image files and displays the thumbnail images on display unit 44 (Step 111).

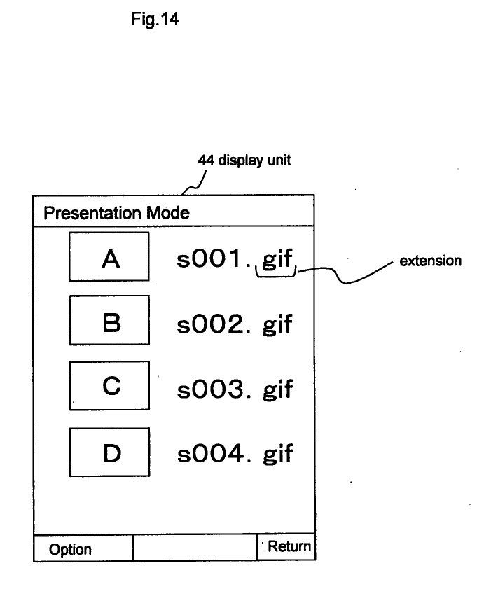

FIG. 14 shows display unit 44 of portable terminal 40 in which the thumbnail images of all images that are to be used in the presentation are displayed.

As shown in FIG. 14, the thumbnail images received from projector 20 are displayed on display unit 44 of portable terminal 40. In addition, because the image file format that can be decoded in portable terminal 40 is only GIF, the thumbnail image files are all in GIF format, as can be seen from the extension portions.

Subsequently, thumbnail images displayed on portable terminal 40 are selected and image selection instructions or image rotation instructions can be issued to projector 20 as in the first exemplary embodiment.

Thus, in the present exemplary embodiment, thumbnail images of images that have been transmitted from a portable terminal (portable terminal 10) and that are stored in projector 20 can be displayed on another portable terminal (portable terminal 40).

In the above-described two exemplary embodiments, a projector converts an image file format that cannot be decoded in a portable terminal to an image file format that can be decoded in the portable terminal, but the component that converts the image file format is not limited to a projector. For example, conversion of image file formats can be carried out in a printer. In this case, images that are to be printed in a printer are checked in a portable terminal, and image output or image rotation instructions are issued to the printing section of the printer from the portable terminal.

In the above-described two exemplary embodiments, only thumbnail image files were transmitted from the projector to a portable terminal, but the projector can also generate image files in an image file format that can be decoded by the portable terminal and transmit the image files, whereby images of higher resolution can be viewed on the display unit of the portable terminal.

Further, although examples were described in the two exemplary embodiments described hereinabove in which the rotation of an image was taken as an image process carried out from a portable terminal, the enlargement of an image, the reduction of an image, or a partial enlargement of an image can be taken as the image process that is carried out from the portable terminal.

In addition, either a cable or a wireless connection may be used as the method of connecting a portable terminal and a projector in the present invention. More specifically, a connection such as a cable LAN, USB (Universal Serial Bus), and RS-232C can be considered in a cable connection, and a wireless LAN, Bluetooth, and infrared ray communication (IrDA) can be considered in a wireless connection.

Portable terminals in which the present invention can be applied include portable telephones, PHS (Personal Handyphone System), extension telephone handsets for in-house use, and PDAs (Personal Data Assistants).

Although the invention of the present application has been described hereinabove with reference to exemplary embodiments, the invention of the present application is not limited to the above-described exemplary embodiments. The constitution and details of the invention of the present application are open to various modifications within the scope of the invention of the present application that will be clear to one of ordinary skill in the art.

1. An image selection system that facilitates selection of output images and that is composed of an image output apparatus and a portable terminal that supplies image files indicating images that are to be supplied as output by the image output apparatus; wherein:
said portable terminal is equipped with:
a display unit; and
a portable-side information processor equipped with at least one decoder that decodes image files;
said image output apparatus is equipped with an image output apparatus-side information processor that is provided with a plurality of decoders that each decode various types of image files;
said portable-side information processor transmits information indicating image file formats that can be decoded by said portable-side information processor to said image output apparatus-side information processor and then receives and decodes image files from said image output apparatus-side information processor and displays on said display unit; and
said image output apparatus-side information processor, upon receiving information indicating image file formats from said portable-side information processor, generates converted image files in which images held by said image output apparatus are converted to an image file format indicated by the received information and transmits the converted image files to said portable-side information processor.

2. The image selection system as set forth in claim 1, wherein:
said portable terminal includes a portable-side storage unit that stores image files;
said portable-side information processor transmits to said image output apparatus-side information processor information indicating image file formats that can be decoded by said portable-side information processor together with image files that are stored in said portable-side storage unit, and then receives and decodes image files from said image output apparatus-side information processor and displays on said display unit; and
said image output apparatus-side information processor, upon receiving said image files and information indicating image file formats from said portable-side information processor, generates an image in which the image file that was received is decoded, generates a converted image file in which the generated image is converted to an image file format indicated by the received information and transmits the converted image file to said portable-side information processor.

3. The image selection system as set forth in claim 2, wherein:
said image output apparatus includes an image output unit and an image output apparatus-side storage unit;
said image output apparatus-side information processor both causes decoded images to be stored in said image output apparatus-side storage unit and stores said images in association with converted image file names that were generated from said images, and then, upon receiving image file names transmitted from said portable-side information processor, acquires from said image output apparatus-side storage unit images that are stored in association with the image file names based on the image file names, and supplies the acquired images to said image output unit;
said portable terminal includes an input unit;
said input unit accepts the selection of an output image from among images received from said image output apparatus that are displayed on said display unit and transmits the image file name of the selected image to said portable-side information processor;
said portable-side information processor, upon receiving an image file name that has been transmitted from said input unit, transmits the received image file name and an image output instruction to said image output apparatus-side information processor.

4. The image selection system as set forth in claim 3, wherein:
said portable-side information processor: displays on said display unit types of image processing for an image that is selected, and then, upon receiving a type of image processing and an image file name transmitted from said input unit, transmits to said image output apparatus-side information processor the received image file name and an image processing instruction according to said type of image processing;
said input unit: accepts input for selecting the type of image processing and an image for which image processing is to be carried out from among images received from said image output apparatus and displayed on said display unit, and transmits to said portable-side information processor the image file name of the image that was selected and said type of image processing; and
said image output apparatus-side information processor: upon receiving an image file name and an image processing instruction transmitted from said portable-side information processor, based on said image file name, acquires the image that is stored in association with the image file name from said image output apparatus-side storage unit, carries out processing according to the image processing instruction that was received for the image that was acquired, and in addition to storing the image for which said image processing has been completed in said image output apparatus-side storage unit, generates an image file from said image that was acquired and transmits the image file to said portable-side information processor.

5. The image selection system as set forth in claim 4, wherein the instruction of image processing that is issued by said portable-side information processor comprises an image rotation instruction.

6. The image selection system as set forth in claim 1, wherein the converted image files that are generated by said image output apparatus-side information processor comprise thumbnail image files.

7. The image selection system as set forth in claim 1, wherein the image output apparatus comprises a projector and the image output unit comprises a projection unit.

8. The image selection system as set forth in claim 1, wherein the image output apparatus comprises a printer, and the image output unit comprises a printing section.

9. An image output apparatus that includes an image output apparatus-side information processor provided with a plurality of decoders that each decode various types of image files, wherein:
said image output apparatus-side information processor, upon receiving information indicating image file formats, generates a converted image file in which an image held by said image output apparatus is converted to an image file format indicated by the received information and transmits the converted image file to the transmission origin of said information that indicates the image file formats.

10. The image output apparatus as set forth in claim 9, wherein:
said image output apparatus-side information processor, upon receiving said image file and information indicating image file formats, generates an image in which the image file that was received is decoded, generates a converted image file in which the generated image is converted to an image file format that is indicated by the received information and transmits the converted image file to the transmission origin of the image file and the information indicating the image file formats.

11. The image output apparatus as set forth in claim 10, further comprising an image output unit and an image output apparatus-side storage unit; wherein:
said image output apparatus-side information processor both causes a decoded image to be stored in said image output apparatus-side storage unit and stores said image in association with a converted image file name that was generated from said image, and then, upon receiving an image file name, acquires from said image output apparatus-side storage unit the image that is stored in association with the image file name based on the image file name, and supplies the image that was acquired to said image output unit.

12. The image output apparatus as set forth in claim 9, wherein the converted image files that are generated by said image output apparatus-side information processor are thumbnail image files.

13. The image output apparatus as set forth in claim 9, wherein the image output apparatus comprises a projector, and the image output unit comprises a projection unit.

14. The image output apparatus as set forth in claim 9, wherein the image output apparatus comprises a printer, and the image output unit comprises a printing section.

15. (canceled)

16. An image selection method that facilitates the selection of output images and that is equipped with: an image output apparatus equipped with an image output apparatus-side information processor provided with a plurality of decoders that each decode various types of image files; and a portable terminal that supplies image files that indicate images that are to be supplied as output by said image output apparatus and that is equipped with a display unit and a portable-side information processor equipped with at least one decoder that decodes image files, the image selection method comprising processes of:
said portable-side information processor transmitting to said image output apparatus-side information processor information indicating image file formats that said portable-side information processor can decode;
upon receiving information indicating image file formats from said portable-side information processor, said image output apparatus-side information processor generating converted image files in which images held by said image output apparatus are converted to an image file format indicated by the received information and transmitting the converted image files to said portable-side information processor; and
said portable-side information processor receiving and decoding image files from said image output apparatus-side information processor and then displaying on said display unit.

17. (canceled)

18. The image selection system as set forth in claim 2, wherein the converted image files that are generated by said image output apparatus-side information processor comprise thumbnail image files.

19. The image selection system as set forth in claim 3, wherein the converted image files that are generated by said image output apparatus-side information processor comprise thumbnail image files.

20. The image selection system as set forth in claim 4, wherein the converted image files that are generated by said image output apparatus-side information processor comprise thumbnail image files.

21. The image selection system as set forth in claim 5, wherein the converted image files that are generated by said image output apparatus-side information processor comprise thumbnail image files.

22. The image selection system as set forth in claim 2, wherein the image output apparatus comprises a projector and the image output unit comprises a projection unit.
